(19) United States
(12) Patent Application Publication
(10) Pub. No.: US 2005/0076136 A1
(43) Pub. Date: Apr. 7, 2005

(54) Apparatus and method for streaming multimedia data

(75) Inventors: Dae-Sung Cho, Seoul (KR); Mi-Young Kim, Daejeon (KR); Sang-Wook Kim, Seoul (KR); Sang-Jo Lee, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/646,831

(22) Filed: Aug. 25, 2003

(30) Foreign Application Priority Data
Sep. 17, 2002 (KR) 2002-56487

(51) Int. Cl. G06F 15/16

(52) U.S. Cl. 709/231

(57) ABSTRACT

A multimedia streaming apparatus and method by which multimedia data is adaptively transmitted according to the conditions of a network are provided. The multimedia streaming apparatus streams multimedia data corresponding to a predetermined QoS level in response to a parsing result of metadata corresponding to multimedia data intended to be provided and information on a network bandwidth measured by a client which receives the multimedia data. Accordingly, adaptive multimedia streaming corresponding to the bandwidth change of the network can be performed without imposing an additional burden on a server.

### BACKGROUND OF THE INVENTION

This application claims the priority of Korean Patent Application No. 2002-56487, filed on Sep. 17, 2002, which is incorporated herein in its entirety by reference.

1. Field of the Invention

The present invention relates to transmission of multimedia data, and more particularly, to a multimedia streaming apparatus and method by which multimedia data is adaptively transmitted according to the conditions of a network.

2. Description of the Related Art

Streaming is a technology by which data to be transmitted can be processed so that data transmission takes place endlessly and continuously. The streaming technology has been increasingly important in line with the growth of the Internet. This is because most users do not have Internet connection lines fast enough to rapidly download voluminous multimedia files. If the streaming technology is used, data can be presented by a client browser or plug-in even before full transmission of a file is not completed.

However, in the streaming environment the conditions under which a network works are not always constant. Generally, even though multimedia streaming service is provided corresponding to an initial bandwidth of a network, if the number of service receivers increases, the bandwidth decreases and even in a worse case, a congestion of the network occurs such that stable service cannot be guaranteed. Accordingly, streaming service which changes the transmission rate correspondingly to the changes in the network is needed.

Adaptive streaming is a technology which appropriately adjusts the amount of transmission data to changes in the conditions under which a network works. Implementation examples of adaptive streaming include the following.

U.S. Pat. No. 6,014,694, “System for adaptive video/audio transport over a network,” granted to Aharoni et al. in January 2000, discloses a multiple bit stream service in which expected bit rates are divided into a plurality of levels, and multimedia streams corresponding to respective bit rates are generated and stored together. According to this method, a stream for each frame is stored or a stream corresponding to each bit rate level is separately stored, and then each server selectively streams a corresponding stream. However, this method has a shortcoming in that the size of a storage stream for servicing one multimedia content is big.

U.S. Pat. No. 6,091,777, “Continuously adaptive digital video compression system and method for a web streamer,” granted to Guetz et al. in July 2000, discloses a method for encoding data by adjusting the compression rate of an image when data is transmitted, considering the bandwidth of a channel and the conditions of resources of a client. However, this method adjusts the compression rate of a next frame by comparing tile current bandwidth with the compression rate of the previous frame for every frame such that the amount of computation is great and overhead of a server is large.

U.S. Pat. No. 6,181,711, “System and method for transporting a compressed video and data bit stream over a communication channel,” granted to Zhang et al. in January 2001, discloses a method by which the bit rate of pre-compressed data is converted and the data is again encoded corresponding to the bandwidth of a network and then transmitted. The bit rate conversion includes a decoding process, a bit rate conversion process, and an encoding process. According to the method, whenever the bandwidth of the network varies, the bit rate conversion should be performed through the above processes, thereby causing an increase on a load of a server. In addition, unless real time encoding is satisfactorily accomplished, a stable service cannot be guaranteed.

### SUMMARY OF THE INVENTION

The present invention provides a multimedia streaming apparatus and method by which optimal multimedia streaming service is provided by adaptively changing a transmission rate according to the bandwidth change of a network without imposing a burden on a server.

According to an aspect of the present invention, there is provided a multimedia streaming apparatus comprising a multimedia streaming server which streams multimedia data corresponding to a predetermined quality of service (QoS) level in response to the parsing result of metadata corresponding to multimedia data desired to be provided for service and network bandwidth information which is input form the outside; and a multimedia streaming client which measures the bandwidth of a network to which the server is connected, by using a time when multimedia data is received and information on the size of the multimedia data, and transmits the measured bandwidth information to the server.

According to another aspect of the present invention, there is provided a multimedia streaming server comprising a data storage unit which stores multimedia data desired to be provided for service and metadata related to the multimedia data; a metadata parsing unit which parses the metadata and outputs the parsing result in the form of a descriptor; a message receiving unit which receives network bandwidth information from the client; a quality of service (QoS) processing unit which selects a QoS level available for service in response to the descriptor information and the network bandwidth information, and extracts multimedia data corresponding to the selected QoS level, from the data storage unit; a buffer which stores the extracted data; a packet generation unit which packetizes the data stored in the buffer; and a packet transmission unit which transmits the data stored in the buffer to the client in each predetermined time interval.

According to another aspect of the present invention, there is provided a multimedia streaming client comprising a packet receiving unit which receives the multimedia data from the server; a buffer which stores the received multimedia data; a multimedia decoder which reproduces the data stored in the buffer; a bandwidth measuring unit which measures a network bandwidth by using the time when the multimedia data is received in the packet receiving unit and the size information of the data; and a message transmission unit which transmits the measured network bandwidth to the server so that the transmission rate of the multimedia data transmitted from the server is adjusted to the network bandwidth.

According to another aspect of the present invention, there is provided a multimedia streaming method to be performed between a server and a client that are connected through a network, the method comprising (a) the client transmitting a service request message and session connection request message to the server; (b) transmitting a service confirmation message on the request message and a pair of dummy packets to the client; (c) in response to the pair of packets transmitted by the server, determining an initial bandwidth value of the network and transmitting the determined initial bandwidth value to the server; (d) comparing the initial bandwidth information transmitted by the client with descriptor information obtained as a result or parsing metadata, determining an appropriate QoS level, and starting to provide multimedia streaming service according to a transmission rate corresponding to the QoS level; (e) in response to packet information transmitted by the streaming service of the server, measuring the network bandwidth periodically and transmitting the measured bandwidth value to the server; and (f) according to the network bandwidth value transmitted by the client, extracting a predetermined multimedia stream, and transmitting the extracted multimedia stream to the client.

According to another aspect of the present invention, there is provided a streaming method of a server which is connected to a client through a network, the method comprising (a) receiving the bandwidth of the network from the client; (b) based on a descriptor obtained as a result of parsing metadata corresponding to multimedia data desired to be provided for service, selecting a current time segment; (c) comparing a target bit rate defined in the descriptor for the selected segment with the network bandwidth, selecting a QoS level available for service; and (d) extracting frames corresponding to the selected QoS level and transmitting the frames to the client at each predetermined time interval.

According to another aspect of the present invention, there is provided a network bandwidth measuring method of a client which receives multimedia data from a server through a network, the method comprising (a) setting the size value of an accumulated packet to 0; (b) starting to receive a packet from the server; (c) setting the time when a first packet is received as T1; (d) after the first packet is input till a last packet is input, whenever a packet is input, accumulating the size value of the packet to the size of the accumulated packet; (e) if the last packet is input, setting the time when the last packet is input as T2; (f) measuring the network bandwidth by calculating

$$\frac{Accumulated packet size \times 1000 \times 8}{TS2 - TS1} ;$$

and (g) feeding the measured network bandwidth information back to the server.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of a multimedia streaming server according to a preferred embodiment of the present invention, which provides adaptive multimedia streaming services in a variable network environment;

FIG. 2 is a diagram of the structure of metadata according to a preferred embodiment of the present invention;

FIG. 3 is a diagram of the structure of independent-type metadata according to a preferred embodiment of the present invention;

FIG. 4 is a diagram of the structure of dependent-type metadata according to a preferred embodiment of the present invention;

FIG. 5 is a diagram of the structure of metadata according to a preferred embodiment of the present invention for streaming a video stream and an audio stream at the same time by adjusting a transmission bit rate to the bandwidth change of a network;

FIG. 6 is a block diagram of a multimedia streaming client according to a preferred embodiment of the present invention, which processes a multimedia packet transmitted by a server;

FIG. 7 is a schematic diagram showing a multimedia streaming operation performed between the server of FIG. 1 and the client of FIG. 6;

FIG. 8 is a flowchart showing a network bandwidth measuring method performed in the client shown in FIG. 6;

FIG. 9 is a flowchart showing a multimedia streaming service process performed in the server shown in FIG. 1;

FIG. 10 is a diagram showing an example of adaptively providing streaming service for multimedia data by adjusting a transmission bit rate to the bandwidth change of a network;

FIG. 11 is a diagram showing the bit rate change of a multimedia stream by an adaptive streaming method according to an embodiment of the present invention when the level of quality of service (QoS) is set to 3;

FIG. 12 is a diagram showing the change of a peak signal to noise ratio (PSNR) value when the QoS level is set to 3 as in FIG. 11;

FIG. 13 is a diagram showing the bit rate change of a multimedia stream by an adaptive streaming method according to an embodiment of the present invention when the QoS level is set to 5;

FIG. 14 is a diagram showing the change of a PSNR value when the QoS value is set to 5 as in FIG. 13;

FIG. 15 is a diagram showing the bit rate change of a multimedia stream by an adaptive streaming method according to an embodiment of the present invention when the QoS level is set to 7; and

FIG. 16 is a diagram showing the change of a PSNR value when the QoS value is set to 7 as in FIG. 15.

### DESCRIPTION OF THE PREFERRED EMBODIMENTS

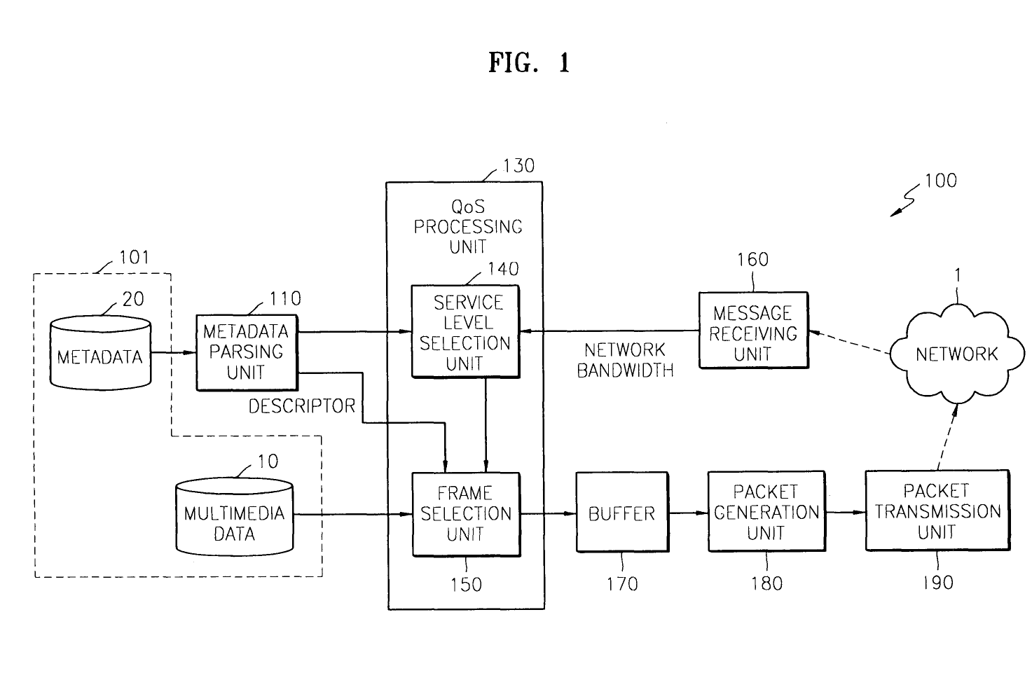

Referring to FIG. 1, the multimedia streaming server 100 according to the present invention comprises a data storage unit 101, a metadata parsing unit 110, a quality of service (hereinafter referred to as ‘QoS’) processing unit 130, a message receiving unit 160, a buffer 170, a packet generation unit 180, and a packet transmission unit.

The data storage unit 101 stores compressed multimedia data intended to be provided for service, and metadata related to the multimedia data. Here, multimedia data is stored in the form of any one of audio data, moving picture data such as video data, still picture data, text data, and graphic data. The multimedia data is formed with a bit stream having any one of a spatial scalable function, a quality scalable function, a temporal scalable function, and a fine grain scalable (FGS) function. The metadata parsing unit 110 parses metadata and outputs the parsing result in the form of a descriptor. The QoS processing unit 130 performs QoS processing in response to the descriptor information of metadata and network bandwidth information. The message receiving unit 160 receives information on conditions of a network 1 (that is, network bandwidth information) from a client. The buffer 170 is formed with two buffers, a packet storage buffer for storing a packet and a packet transmission buffer for transmitting a packet. The packet generation unit 180 packetizes data stored in the packet transmission buffer and the packet transmission unit 190 transmits data stored in the buffer 170 to the network 1 at a predetermined time interval.

QoS processing by the QoS processing unit 130 will now be explained. First, a service level selection unit 140 receives a network bandwidth value from the message receiving unit 160, compares the bandwidth with a target bit rate at each QoS level defined in advance in the descriptor, and selects an available QoS level. Then, the QoS processing unit 130 extracts frames corresponding to the current QoS level and stores the frames in the buffer 170.

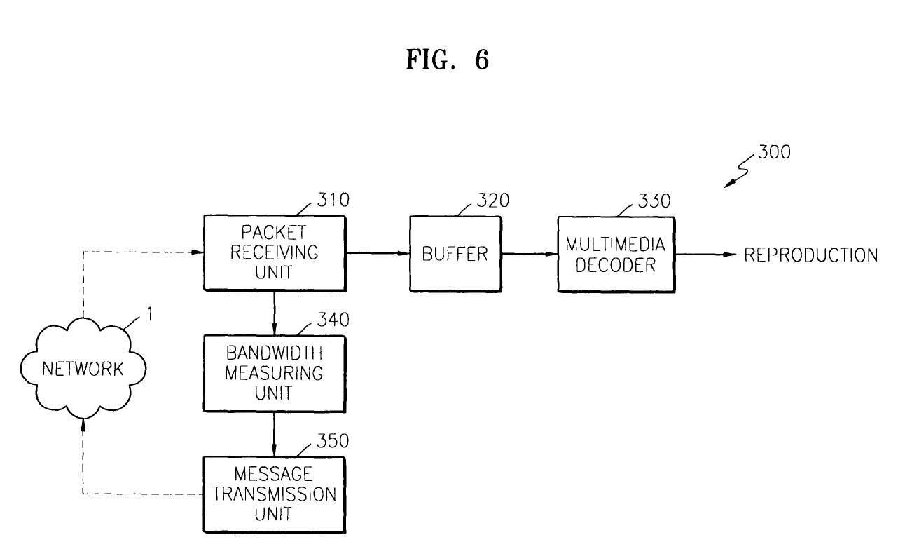

Metadata 20 stores pointer information of frames corresponding to respective levels such that a file stored in the buffer 170 can directly access the metadata 20. The packet generation unit 180 packetizes data stored in the buffer 170 by cutting the data into packets of a predetermined size, and the packet transmission unit 190 transmits the data stored in the buffer to the network 1 at each predetermined time interval. When transmitting data, the packet transmission unit 190 transmits packets with identical intervals such that measuring the bandwidth in the client (300 of FIG. 6) can be performed accurately. A packet transmission interval and the size of a packet are adjusted to the average bit rate of data being provided for service.

The metadata 20 is defined based on an extensible markup language (XML) and has scalability and compatibility according to the advantages of the XML. If a streaming service request is made between the server 100 and a client, the metadata 20 is parsed by the metadata parsing unit 110 and stored in the form of a descriptor so that the descriptor can be used internally in the server 100.

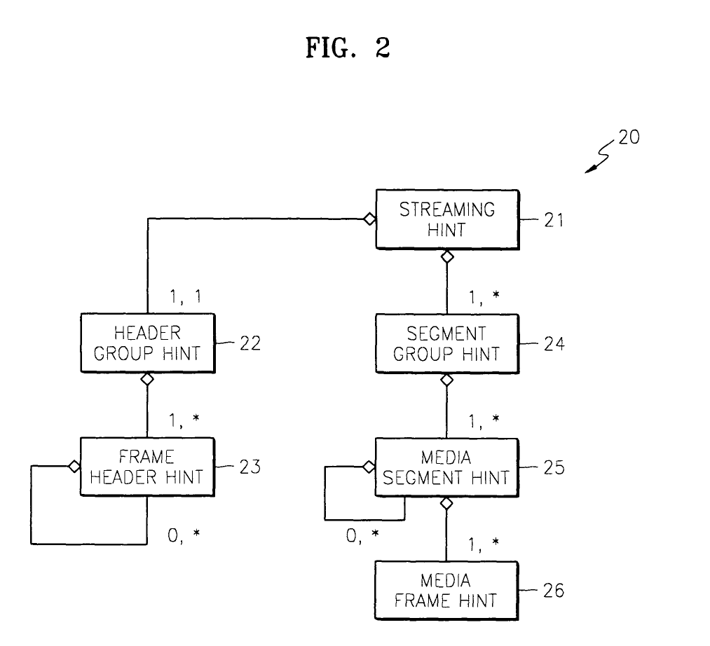

FIG. 2 is a diagram of the structure of metadata according to a preferred embodiment of the present invention. In FIG. 2, boxes 21 through 26 indicate node objects and each line connecting nodes 21 through 26 indicates a hierarchical connection relation. The number next to each line connection part indicates cardinality that shows how many nodes relate to the node. Here, the number “1, 1” next to a line connection part indicates that the maximum number and the minimum number in the connection relation of the two nodes are 1 each, the number “0, *” indicates that the maximum number and the minimum number in the connection relation are 0 and infinity, respectively, and the number “1, *” indicates that the maximum number and the minimum number in the connection relation are 1 and infinity, respectively.

For example, the relation between a STREAMING HINT node 21 and a HEADER GROUP HINT node 22, expressed as “1, 1”, indicates that under the STREAMING HINT node 21 there should be only one HEADER GROUP HINT node 22 and should not be two or more nodes. The relation between the STREAMING HINT node and a SEGMENT GROUP HINT node 24, expressed as “1, *”, indicates that under the STREAMING HINT node 21 there should be one or more SEGMENT GROUP HINT nodes 24 and there is no limit to the number of the SEGMENT GROUP HINT nodes 24.

In FIG. 2, the STREAMING HINT node 21 is a node at the top level and has attribute values specifying control types of the metadata 20 and a hierarchy type of the node. The control types specified in the STREAMING HINT node includes targetBitrateControl, targetQualityControl, targetComplexityControl, targetProfileControl, targetSpeedControl, targetDirectionContral and targetDeviceControl.

The targetBitrateControl is an attribute value for adjusting a transmission bit rate to the bandwidth change of a network, the targetQualityControl is an attribute value for adjusting a target quality of multimedia data to be provided, the targetComplexityControl is an attribute value for supporting differentiated services according to the conditions of resources of a client, the targetProfileControl is an attribute value for supporting differentiated services according to the compression format of multimedia data, the targetSpeedControl is an attribute value for adjusting a service speed according to a reproduction speed adjusting request from a client, the targetDirectionContral is an attribute for adjusting a service direction according to a reproduction direction adjusting request from a client, and targetDeviceControl is an attribute for supporting differentiated services according to the type of a client terminal. In addition, in the STREAMING HINT node 21 control types for QoS other than these control types can be additionally defined. According to the control attribute values of the STREAMING HINT node 21 the attribute of metadata is specified differently.

The hierarch type of the STREAMING HINT node 21 is divided into an independent type and a dependent type, and according to the types, the structure of a lower level node varies. Particularly, a MEDIA SEGMENT HINT node 25 can build independent-type metadata or dependent-type metadata according to its structure.

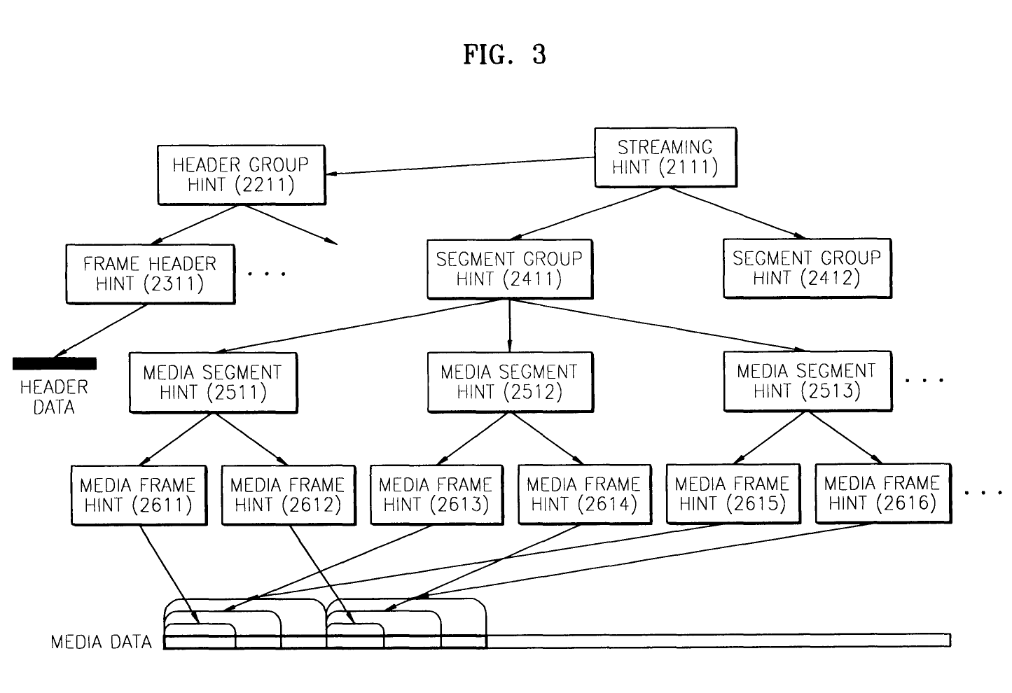

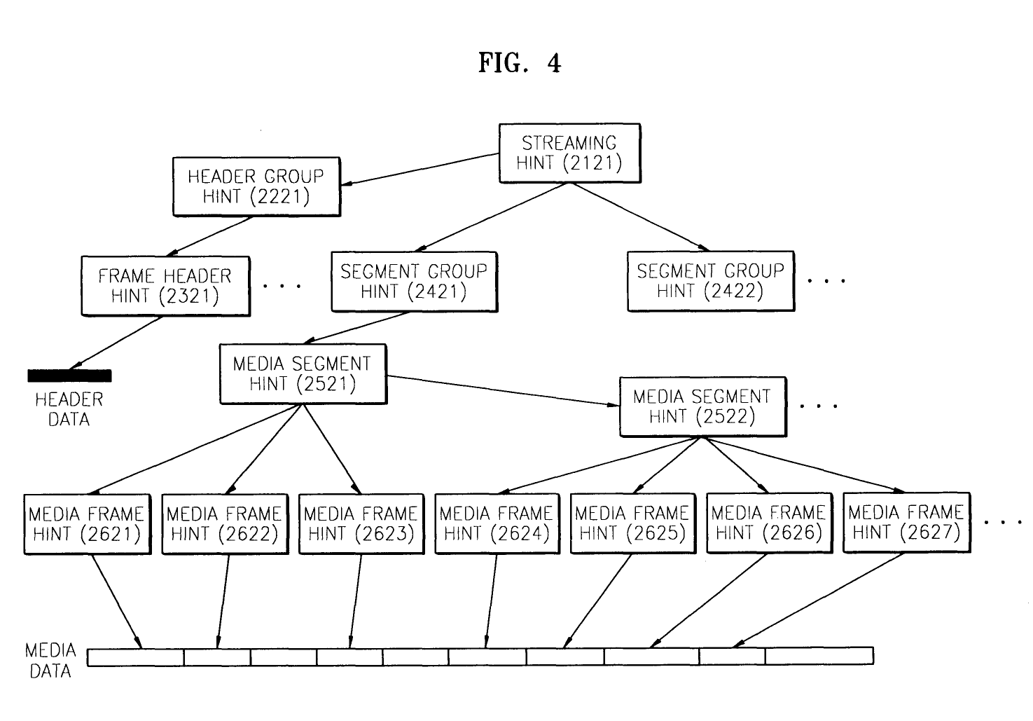

FIG. 3 is a diagram of the structure of independent-type metadata according to a preferred embodiment of the present invention. FIG. 4 is a diagram of the structure of dependent-type metadata according to a preferred embodiment of the present invention.

Referring to FIG. 3, MEDIA SEGMENT HINT nodes 2511 through 2513 have respective connection relations independent of each other. Meanwhile, FIG. 4 shows that a second MEDIA SEGMENT HINT node 2522 has a connection relation dependent on a first MEDIA SEGMENT HINT node 2521. Here, in the independent-type metadata structure each node has frame information of multimedia data corresponding to a service level without reference to an upper node or reuse, while in the dependent-type metadata structure an upper node is referred to for information shared at each level and a lower node specifies only additional information.

Again referring to FIG. 2, the STREAMING HINT node 21 is divided into the HEADER GROUP HINT node 22 having header information and the SEGMENT GROUP HINT node 24 which forms each segment information when multimedia data is divided into units of time, that is, into segments.

The HEADER GROUP HINT node 22 has a number of FRAME HEADER HINT nodes 23 equal to the number of multimedia objects to be provided and each FRAME HEADER HINT node 23 has an attribute value indicating unique information of the node.

Attribute values of the FRAME HEADER HINT node 23 includes streamed, streamType, scalability, frameRate, and avgBitrate. Among these values, streamed is a proper ID for identifying each multimedia data, and streamType is an attribute value indicating the type of multimedia and is divided into visual, audio, and other types. The scalability is an attribute value indicating the types of scalable functions and is divided into spatial, temporal, snr, and fgs (fine grain scalability) types. The spatial indicates a spatially scalable attribute value, the temporal indicates a temporally scalable attribute value, and the snr indicates an attribute value of quality scalability. The sourceLocator indicates location information of multimedia data stored in the data storage unit 101 of the server. The frameRate indicates the frame rate of multimedia data and the avgBitrate indicates the average bit rate of multimedia data.

The SEGMENT GROUP HINT node 24 defines a divided multimedia stream in each time unit as a segment when an entire multimedia stream is divided into predetermined time intervals. The SEGMENT GROUP HINT node 25 has a number of MEDIA SEGMENT HINT nodes 25 equal to the number of QoS levels for each segment. If the number of QoS levels increases, the number of MEDIA SEGMENT HINT nodes 25 increases such that the size of the metadata 20 increases but more detailed service can be provided.

The MEDIA SEGMENT HINT node 25 has a level attribute indicating a QoS level index, a numofFrames attribute value indicating the number of entire frames provided in the QoS level, and a targetBitrate attribute value indicating an average bit rate when a frame of the QoS level is provided for service. The MEDIA SEGMENT HINT node 25 includes at least one or more MEDIA FRAME HINT nodes 26 containing multimedia frame information to be actually transmitted, and has a number of MEDIA FRAME HINT nodes equal to the numofFrames attribute value.

The MEDIA FRAME HINT node 26 has attribute values such as streamed, CTS, DTS, CodingType, frameOffset, frameLength, and frameNo. The streamlD is a proper ID for identifying each multimedia stream when a plurality of multimedia objects are provided for service and has the same value as the streamID of the FRAME HEADER HINT node 23. The DTS and the CTS indicate decoding time information and reproduction time information, respectively, of a frame. According to a frame reference method, frames are divided into I frames, P frames, and B frames when encoding and the CodingType indicates the type of a frame. The frameOffset indicates location information of multimedia data stored in the data storage unit 101 and the frameLength indicates the size of the frame. The frameNo indicates the number of the frame.

These attribute values of the MEDIA FRAME HINT node 26 enables direct access to the multimedia data 10 stored in the data storage unit 101. If the data structure of this metadata is used, adaptive multimedia stream is available even when a plurality of multimedia streams should be provided at the same time for service.

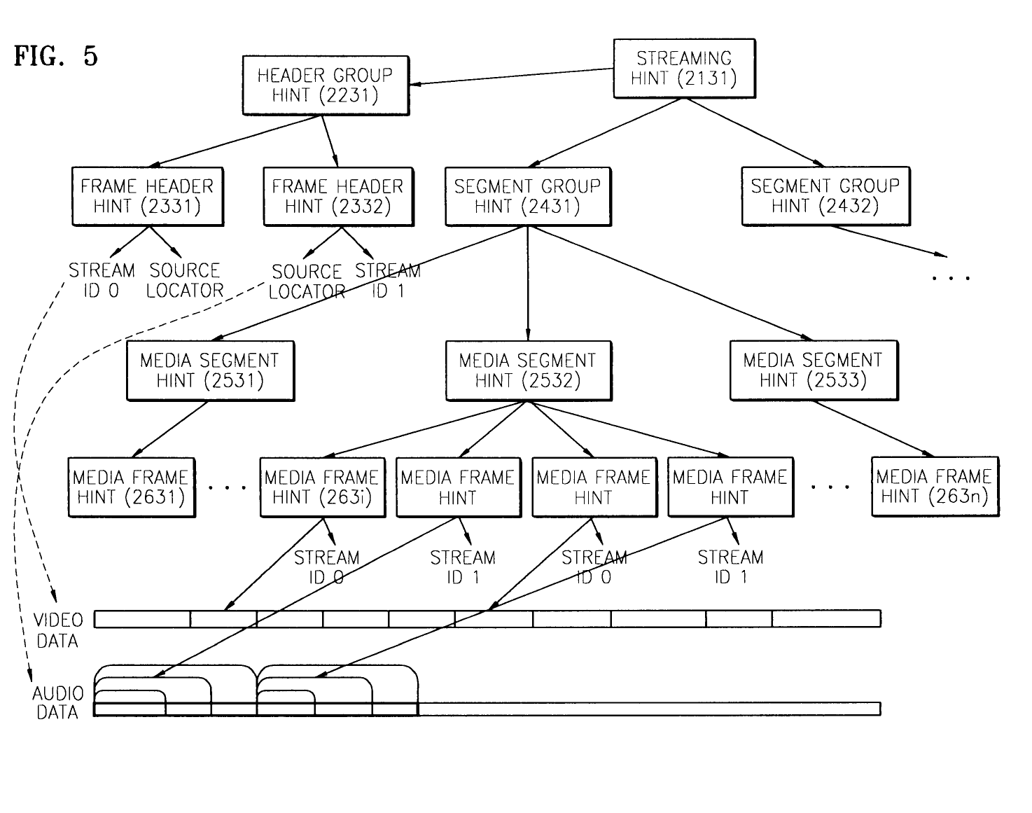

FIG. 5 is a diagram of the structure of metadata according to a preferred embodiment of the present invention for streaming a video stream and an audio stream at the same time by adjusting a transmission bit rate to the bandwidth change of a network.

Referring to FIG. 5, each of MEDIA SEGMENT HINT nodes 2531 through 2533 corresponding to respective QoS level of a unit segment has frame information of both video and audio streams, and distinguishes and accesses each multimedia data stream by using streamID attribute values of MEDIA FRAME HINT nodes 2631 through 263n. For example, when streamID 0 is defined as a video data stream and streamID 1 is defined as an audio data stream, any one of the multimedia data streams is accessed according to whether the streamID attribute value of the MEDIA FRAME HINT node 26 indicates streamID 0 or streamID 1. Thus, when a plurality of streams are provided at the same time, if a multimedia frame to be provided for service is also defined in the metadata, a transmission rate can be adjusted to the bandwidth and synchronization among multimedia data can be successfully performed.

FIG. 6 is a block diagram of a multimedia streaming client 300 according to a preferred embodiment of the present invention, which processes a multimedia packet transmitted by the server 100. Referring to FIG. 6, the multimedia streaming client 300 according to the present invention comprises a packet receiving unit 310, a buffer 320, a multimedia decoder 330, a bandwidth measuring unit 340, and a message transmission unit 350.

The packet receiving unit 310 receives a multimedia stream from the server 100, and the buffer 320 stores the received multimedia stream data. The multimedia decoder 330 reproduces the data stored in the buffer 320, and the bandwidth measuring unit 340 measures a network bandwidth by using the time when the packet receiving unit 310 receives a multimedia packet and information on the size of a packet.

When transmitting data, the server 100 transmits all packets in the buffer 170 in units of packet groups in a predetermined time interval and when transmitting a packet, transmits a packet number together. The packet receiving unit 310 distinguishes the first packet and the last packet in a packet group by using the packet numbers transmitted by the server 100. Assuming that a time when a first packet is received is t1, a time when a last packet is received is t2, and the size of data of a packet group is Sp, the bandwidth of a network can be obtained by the following equation 1:

$${E}_{BW} ( Bandwidth ) = \frac{{S}_{p} \times 8 \times 1000}{{t}_{2} - {t}_{1}} \qquad ( 1 )$$

Here, the unit of time is a millisecond (ms), the unit of the size of data is a byte, and the measuring unit of a bandwidth is bits per second (bps). A measured bandwidth is periodically fed back from the message transmission unit 350 to the server 100 whenever there is a change in the bandwidth.

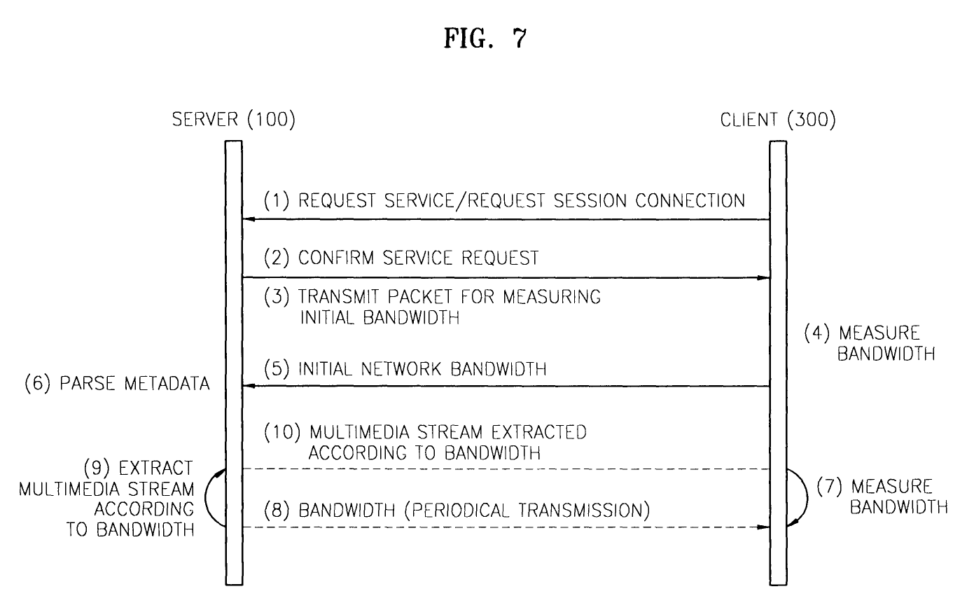

FIG. 7 is a schematic diagram for explaining a multimedia streaming operation performed between the server 100 shown in FIG. 1 and the client 300 shown in FIG. 6. Referring to FIG. 7, in the adaptive multimedia streaming method according to the present invention, a data transmission rate between the server 1 00 and the client 300 is adjusted to the bandwidth of the network by using metadata when data is transmitted. For this, the client 300 first transmits a service request and session connection request to the server 100 (reference number (1)). The server 100 confirms the service request from the client 300 (reference number (2)), and a service confirmation message and a pair of dummy packets to the client 300 (reference number (3)).

The client measures an initial bandwidth (reference number (4)) in response to the pair of packets transmitted by the server 100. The sizes of the two packets transmitted by the server 100 are set to the same as the size of a packet unit, by which size multimedia data is divided into packets when the packet generation unit 180 of the server 100 packetizes the multimedia data. The transmission interval of the two packets is also set to the same as the transmission interval of the multimedia data. After receiving the dummy packet pair from the server 100, the client 300 determines an initial bandwidth value by using the equation 1 and transmits the value to the server 100 (reference number (5)).

When the client 300 measures and transmits the initial bandwidth, the server 100 parses metadata, stores the parsed result in the form of a descriptor, compares the initial bandwidth with the descriptor information, determines an appropriate QoS level, and begins to provide multimedia streaming service (reference number (6)). Using the packet information transmitted by the server 100, the client 300 periodically measures the bandwidth of the network (reference number (7)) and transmits the measured bandwidth value to the server 100 (reference number (8)). The server 100 extracts a predetermined multimedia stream according to the bandwidth value transmitted by the client 300 (reference number (9)) and transmits the extracted multimedia stream to the client 300 (reference number (10)). A data transmission process performed between the multimedia streaming server 100 and the client 300 at this time will now be explained.

As described above, according to the purpose of a buffer, the buffer 170 is broken down into the packet storage buffer for storing a packet and a packet transmission buffer for transmitting a packet. While the packet transmission unit 190 transmits packets stored in the packet transmission buffer, the QoS processing unit 130 stores frames corresponding to the QoS level in the packet storage buffer. At this time, the packet transmission is carried out in each predetermined time interval. If it is a time to transmit a next packet after a packet is transmitted and a predetermined time passes, the packet transmission unit 190 uses the previous packet storage buffer as a packet transmission buffer for transmitting a present packet and uses the previous packet transmission buffer that is empty after transmitting the previous packet, as a packet storage buffer for storing a packet. According to this recursive management of the buffer 170, continuous streaming can be performed while minimizing the changes in the conditions of the network.

The packet transmission unit 190 transmits all the packets stored in the packet transmission buffer in each predetermined time interval and the packets transmitted at this time are defined as a packet group. Packets in the packet group unit have packet numbers which indicate the order of the packets in the transmission. Based on the packet numbers, the client 300 determines the order of packets and the beginning and end of the packet group, and measures the bandwidth in units of packet groups. The process for measuring a bandwidth in the client 300 will now be explained.

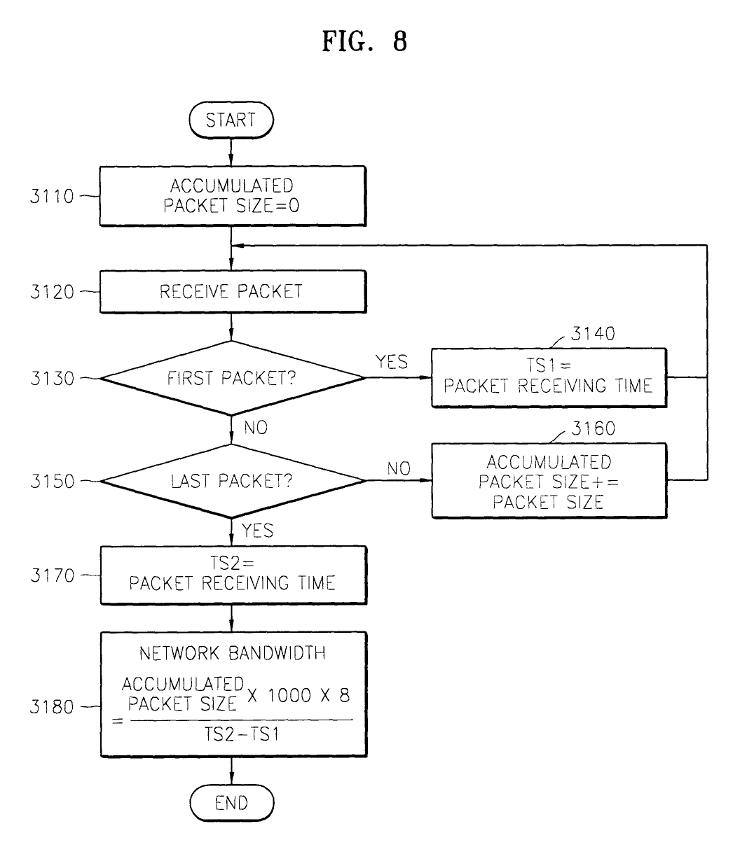

FIG. 8 is a flowchart showing a network bandwidth measuring method performed in the packet receiving unit 310 of the client 300 shown in FIG. 6.

Referring to FIG. 8, the packet receiving unit 310 initializes an accumulated packet size value which indicates the entire size of a received packet, by setting the value to 0 in step 3110 and receives a packet in step 3120. If the packet receiving unit 310 receives a packet, a header and data are separated in the packet and from the header the packet number is obtained. Using the packet number, it is determined whether or not the received packet is the first packet in step 3130.

If the determination result of the step 3130 indicates that the received packet is the first packet, the receiving time of the first packet is set as TS1 in step 3140 and the step 3120 is performed again to continuously receive a packet. Then, it is determined whether or not the received packet is the first packet in step 3130, and if the determination result indicates that the received packet is not a first packet, it is determined whether or not the packet is the last packet in step 3150.

If the determination result of the step 3150 indicates that the received packet is not the last packet, the size value of the current packet is accumulated to the size value of the existing accumulated packet and the step 3120 is performed again to continuously receive a packet. Then, it is determined whether or not the received packet is the first packet in step 3130, and if the determination result indicates that the received packet is not a first packet, it is again determined whether or not the packet is the last packet in step 3150.

If the determination result of the step 3150 indicates that the received packet is the last packet, the receiving time of the last packet is set as TS2 in step 3170. Then, by plugging in the receiving time of the first packet TS1, the receiving time of the last packet TS2, and the size value of the accumulated packet into the equation 1, that is, by calculating

$$\frac{Accumulated packet size \times 1000 \times 8}{TS2 - TS1} ,$$

the bandwidth of the network is measured in step 3180.

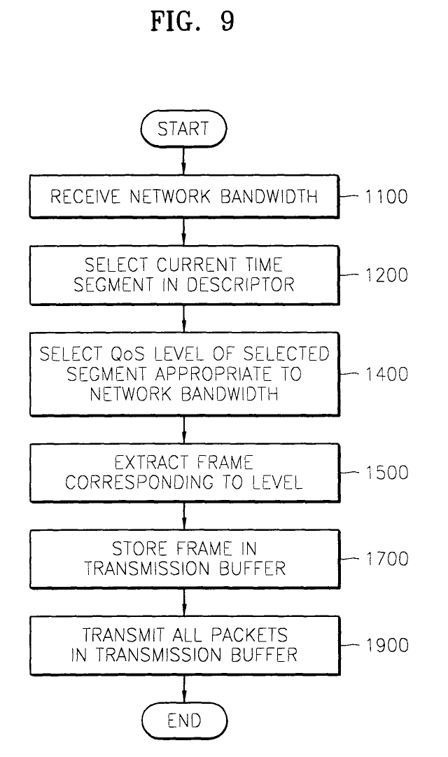

FIG. 9 is a flowchart showing a multimedia streaming service process performed in the server 100 shown in FIG. 1. Referring to FIG. 9, first, the server 100 receives the bandwidth of the network from the client 300 in step 1100, and selects a current time segment from the descriptor generated based on the metadata in step 1200. Then, by comparing the bandwidth with a target bit rate defined in the descriptor for the selected segment, the server 100 selects a QoS level available for service in step 1400. The number of QoS levels is determined when the metadata is defined and the target bit rate of each level is determined based on an average bit rate of multimedia data. Since the metadata contains information on frames corresponding to each level, if the QoS level is determined, only the frames corresponding to the selected level are extracted in step 1500 and stored in the buffer in step 1700. Then, through the packet transmission unit 190, data stored in the buffer 170 is transmitted to the client 300 in each predetermined time interval.

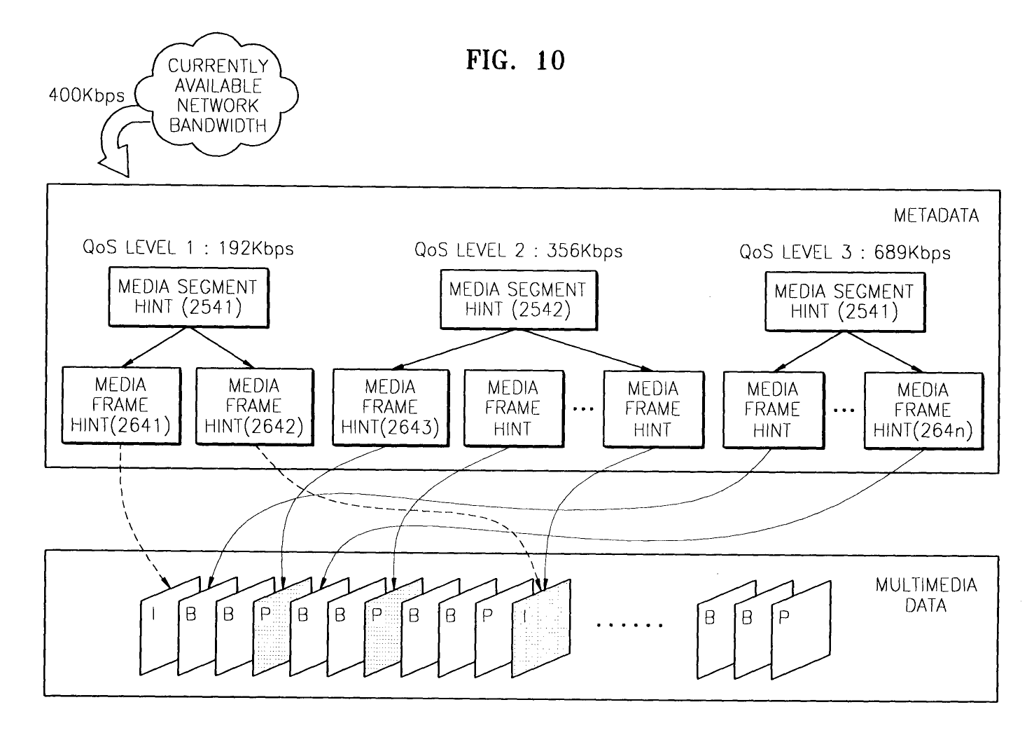

FIG. 10 is a diagram showing an example of adaptively providing streaming service for multimedia data by adjusting a transmission bit rate to the bandwidth change of a network.

Referring to FIG. 10, for example, if the bandwidth of the current network detected by the client 300 is 400 kbps, the server 100 selects an appropriate QoS level from the metadata. As shown in FIG. 10, when the bandwidth of the network is 400 kbps, the QoS level is formed by 3 classes and at this time each of MEDIA SEGMENT HINT nodes 2541 through 2543 indicates a QoS level. For example, assuming that targetBitrate value, i.e., one of the attributes of MEDIA SEGMENT HINT nodes 2541 through 2543, is level 1, the bit rate is set to 192 kbps, if the value is level 2, the bit rate is set to 356 kbps, and if the value is level 3, the bit rate is set to 689 kbps, level 2 that has a target bit rate value closest to the current bandwidth (that is, 400 kbps) is selected as the QoS level.

The MEDIA SEGMENT HINT nodes 2541 through 2543 have MEDIA FRAME HINT nodes 2641, 2642, . . . , 264m in respective subordinate levels and each of the MEDIA FRAME HINT nodes 2641, 2642, . . . , 264n stores information on frames that can support the corresponding target bit rate. In this case, the bandwidth of the network may not be fixed to 400 kbps and may vary. If the bandwidth varies, then a QoS level to be selected also varies accordingly. Therefore, if the server 100 selects frames corresponding to the QoS level (for example, QoS level 2) appropriate to the bandwidth of the current network and transmits the frames, the data transmission rate is adjusted to the bandwidth of the current network such that adaptive streaming can be achieved.

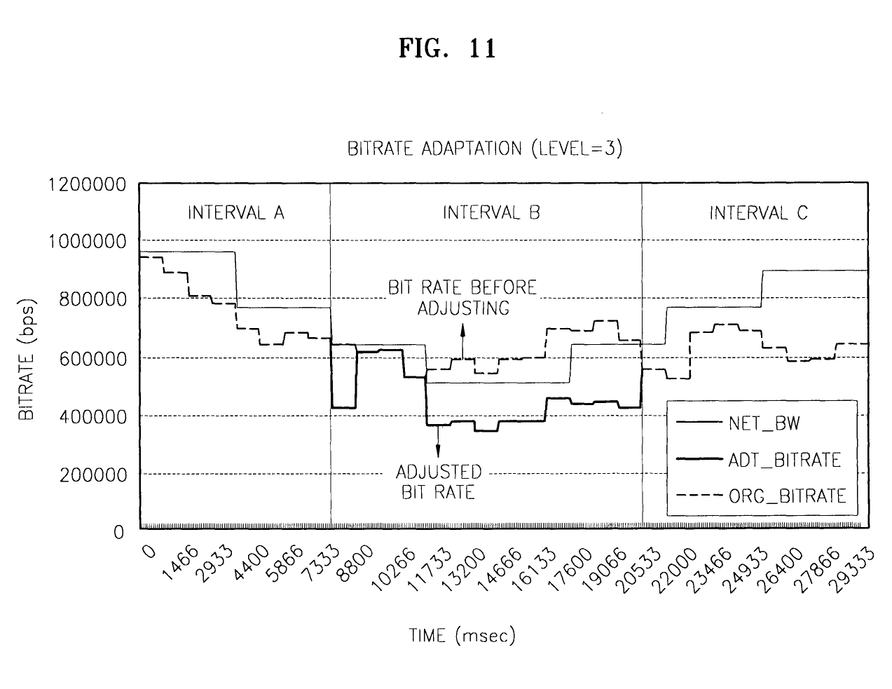

FIG. 11 is a diagram showing the bit rate change of a multimedia stream by an adaptive streaming method according to the present invention when the QoS level is set to 3. The graph shown in FIG. 11 is the result of adaptive streaming when sequence data with a common intermediate format (CIF) size of 352×288, a frame rate of 30 fps and an average bit rate of 658 kbps is used. The graph shows the bandwidth of the network (net_bw), the bit rate before adjusting (org_bitrate), and the adjusted bit rate (adt_bitrate) according to the present invention with the lapse of time when the QoS level is divided into three classes.

Referring to FIG. 11, the network bandwidth (net_bw) gradually decreases in interval A, reaches a minimum in interval B, and recovers in interval C. At this time, since the original bit rate (org_bitrate) of the data before adjusting is less than the network bandwidth (net_bw) in the interval A, bit rate adjusting by QoS level does not occur. Likewise, since the original bit rate (org_bitrate) of the data before adjusting is less than the network bandwidth (net_bw) in the interval C, bit rate adjusting by QoS level does not occur. However, since the original bit rate (org_bitrate) of the data before adjusting is greater than the network bandwidth (net_bw) in the interval B, if this state continues for a long time, network congestion occurs and packets may be dropped during transmission. Therefore, in the present invention the bit rate is adjusted to the network bandwidth (net_bw) according to the QoS level in the interval B such that packet drop, which can occur during transmission, can be prevented.

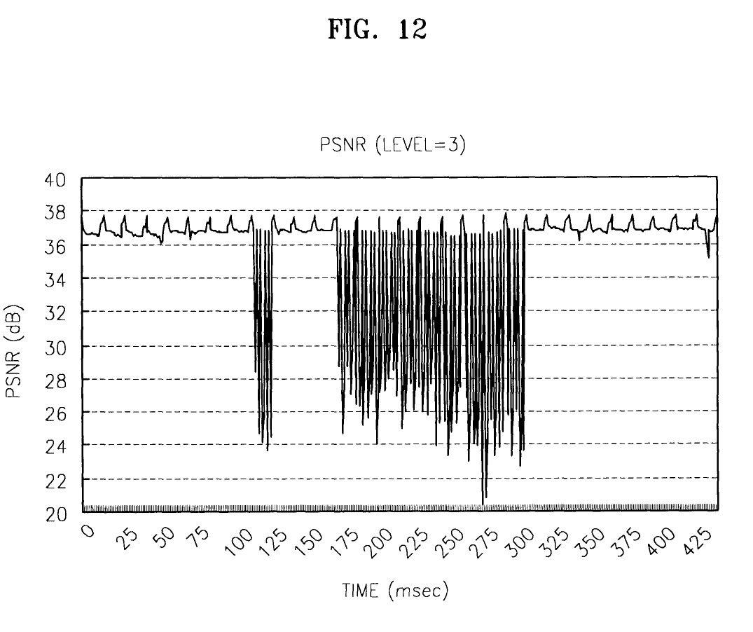

FIG. 12 is a diagram showing the change of a peak signal to noise ratio (PSNR) value when the QoS level is set to 3 as in FIG. 11.

PSNR is obtained by the following equations 2 and 3:

$$RMSE = \sqrt{\frac{1}{MN} {\sum }_{i = 0}^{M - 1} {\sum }_{j = 0}^{N - 1} {[ f ( i , j ) - \overline{f} ( i , j ) ]}^{2}} \qquad ( 2 )$$

The equation 2 is originally an equation for calculating the root mean square error (RMSE) of a decoded image for an original image. Here, f(i,j) denotes the pixel value of the original image and \overline{f}(i,j) denotes the pixel value of the decoded image. M and N denote the number of pixels of the original image and that of the decoded image, respectively.

If the RMSE of the decoded image for the original image is obtained according to the equation 2, PSNR value is obtained by the following equation 3:

$$PSNR = 20 {log}_{10} ( \frac{255}{RMSE} ) \qquad ( 3 )$$

The part where the PSNR value dramatically decreases in the graph of FIG. 12 indicates the part where a frame drop occurs for adjusting the bit rate. At this time, the average PSNR is 34.87 dB.

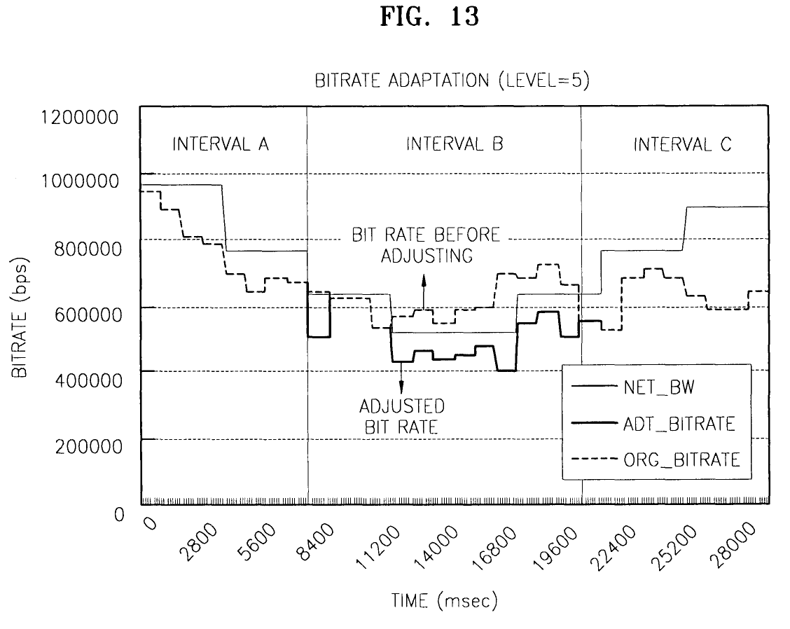

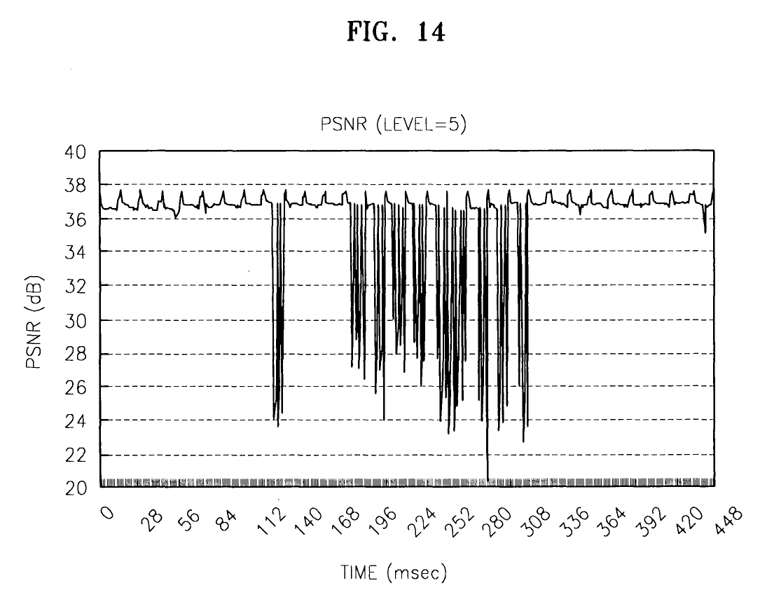

FIG. 13 is a diagram showing the bit rate change of a multimedia stream by an adaptive streaming method according to the present invention when the QoS level is set to 5. FIG. 14 is a diagram showing the change of a PSNR value when the QoS value is set to 5 as in FIG. 13. The graphs of FIGS. 13 and 14 show the results of experiments performed under the same conditions as the experiments of FIGS. 11 and 12.

Referring to FIG. 13, the adjusted bit rate (adt_bitrate) of data when the QoS level is set to 5 is provided more appropriately to the change of the network bandwidth (net_bw) compared to that of FIG. 11 when the QoS level is set to 3. Therefore, in the frame drop rate and average bit rate, the adjusted bit rate when the QoS level is set to 5 can get more improved results than the adjusted bit rate when the QoS level is set to 3.

Next, referring to FIG. 14, it is shown that the part where the PSNR value is dramatically lowered shrinks in the graph of FIG. 14 compared to the part in FIG. 12. This means that the part where frame drop occurs shrinks. When the QoS level is set to 5 as FIG. 14, the average PSNR is 35.57 dB.

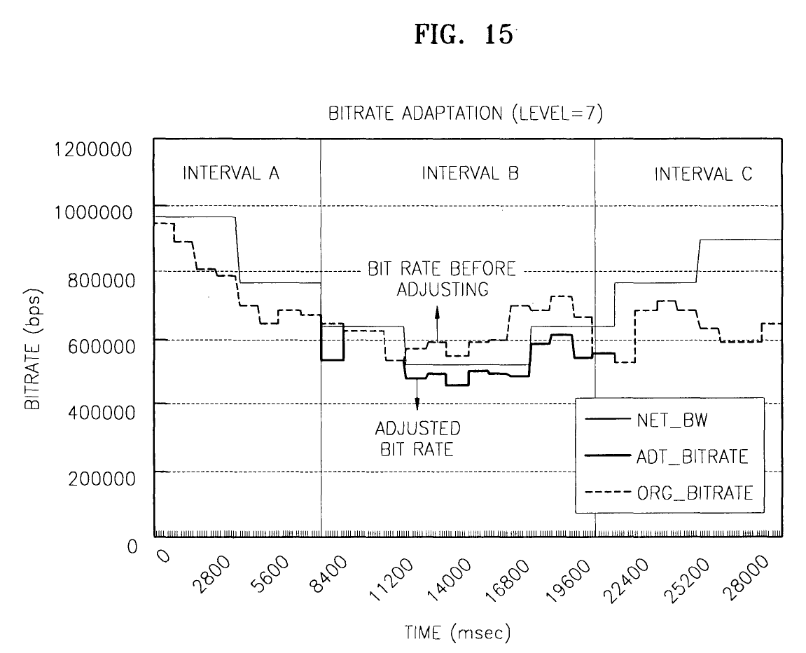

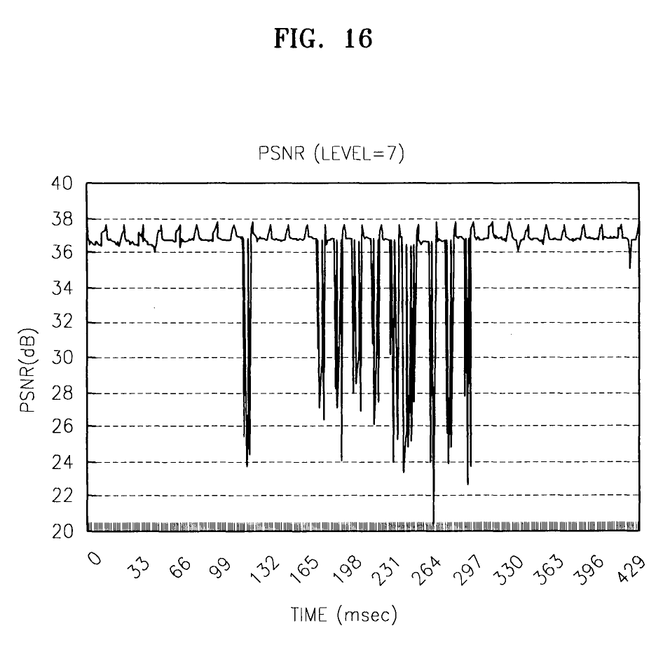

FIG. 15 is a diagram showing the bit rate change of a multimedia stream by an adaptive streaming method according to the present invention when the QoS level is set to 7, and FIG. 16 is a diagram showing the change of a PSNR value when the QoS value is set to 7 as in FIG. 15. The graphs of FIGS. 15 and 16 show the results of experiments performed under the same conditions as the experiments of FIGS. 11 and 12.

Referring to FIG. 15, the adjusted bit rate (adt_bitrate) of data when the QoS level is set to 7 is provided more appropriately to the change of the network bandwidth (net_bw) compared to that when the QoS level is set to 3 or 5. Therefore, in the frame drop rate and average bit rate, the adjusted bit rate when the QoS level is set to 7 can get more improved results than the adjusted bit rate when the QoS level is set to 3 or 5.

Next, referring to FIG. 16, it is shown that the part where the PSNR value is dramatically lowered shrinks in the graph of FIG. 16 compared to the parts in FIG. 12 and FIG. 14. This means that the part where frame drop occurs shrinks greatly. When the QoS level is set to 7 as FIG. 16, the average PSNR is 35.89 dB.

The results obtained in FIGS. 11 through 16 can be centralized as in the following Table 1:

TABLE 1

| Number of | Frame drop | Average bit | |
|---|---|---|---|
| QoS levels | rate (%) | rate (bps) | Average PSNR (dB) |
| 3 | 19.3 | 583.596 | 34.87 |
| 5 | 12.7 | 608.964 | 35.57 |
| 7 | 9.6 | 621.112 | 35.89 |

As shown in the Table 1 and FIGS. 11 through 16, the present invention can provide services more appropriately to the change of the network bandwidth as the number of QoS levels increases (that is, as the QoS level is divided more finely). As the number of QoS levels increases, the frame drop rate decreases and the average bit rate and the average PSNR increase. Accordingly, as the number of QoS levels increases, more detailed control of a transmission rate is enabled. Therefore, the multimedia streaming apparatus and method according to the present invention can provide multimedia streaming services adaptively according to the change of the network bandwidth without imposing a burden on the server.

As described above the adaptive streaming apparatus and method according to the present invention can provide optimum streaming services regardless of the condition of a network and the type of a terminal that receives the services. If only metadata is specified together with multimedia data, the apparatus and method can be applied regardless on the format of contents to be delivered, and compared to prior art method, the burden on the server decreases in streaming. Also, the present invention can be applied to data streaming in a wireless communications network as well as in a wire communications network.

The present invention may be embodied in a code, which can be read by a computer, on a computer readable recording medium. The computer readable recording medium includes all kinds of recording apparatuses on which computer readable data are stored.

The computer readable recording medium includes storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording medium can be used via computer systems connected through a network and can be stored and executed in a distributed mode.

1. A multimedia streaming apparatus comprising:
a multimedia streaming server which streams multimedia data corresponding to a predetermined quality of service (QoS) level in response to a parsing result of metadata corresponding to multimedia data intended to be provided for service and network bandwidth information which is input form the outside; and
a multimedia streaming client which measures the bandwidth of a network to which the server is connected, by using a time when multimedia data is received and information on the size of the multimedia data, and transmits the measured bandwidth information to the server.

2. The multimedia streaming apparatus of claim 1, wherein the multimedia streaming server comprises:
a data storage unit which stores multimedia data desired to be provided for service and metadata related to the multimedia data;
a metadata parsing unit which parses the metadata and outputs the parsing result in the form of a descriptor;
a message receiving unit which receives the network bandwidth information from a client;
a quality of service (QoS) processing unit which selects a QoS level available for service in response to the descriptor information and the network bandwidth information, and extracts multimedia data corresponding to the selected QoS level, from the data storage unit;
a buffer which stores the extracted data;
a packet generation unit which packetizes the data stored in the buffer; and
a packet transmission unit which transmits the data stored in the buffer to the client in each predetermined time interval.

3. The multimedia streaming apparatus of claim 2, wherein the QoS processing unit comprises:
a service level selection unit which compares a target bit rate for each QoS level with the bandwidth and selects a predetermined QoS level; and
a frame selection unit which extracts frames corresponding to the QoS level from the multimedia data stored in the data storage unit and stores the extracted frames in the buffer.

4. The multimedia streaming apparatus of claim 2, wherein the buffer comprises:
a packet storage buffer which stores the packet; and
a packet transmission buffer which transmits the packet.

5. The multimedia streaming apparatus of claim 2, wherein the multimedia data has any one form of audio data, moving picture data, still picture data, text data, and graphic data.

6. The multimedia streaming apparatus of claim 2, wherein the multimedia data is formed with a bit stream which has any one of a spatial scalable function, a quality scalable function, a temporal scalable function, and fine grain scalable (FGS) function.

7. The multimedia streaming apparatus of claim 2, wherein the metadata is defined based on an extensible markup language (XML).

8. The multimedia streaming apparatus of claim 2, wherein the metadata has a hierarchical structure in the form of a tree having the multimedia data and streaming-related information.

9. The multimedia streaming apparatus of claim 8, wherein the metadata comprises:
a STREAMING HINT node which specifies the control type of the metadata and the type of the hierarchical structure of a node;
a HEADER GROUP HINT node which is connected to the STREAMING HINT node as a subordinate node of the STREAMING HINT node and contains header information of the multimedia data;
at least one or more SEGMENT GROUP HINT nodes, each of which is connected to the STREAMING HINT node as a subordinate node of the STREAMING HINT node and contains segment information when the multimedia is divided into segments of a predetermined time interval;
at least one or more FRAME HEADER HINT nodes, each of which is connected to the HEADER GROUP HINT node as a subordinate node of the HEADER GROUP HINT node, and contains an attribute value indicating unique information of each node;
at least one or more MEDIA SEGMENT HINT nodes, each of which is connected to the SEGMENT GROUP HINT node as a subordinate node of the SEGMENT GROUP HINT node, and contains attribute information on each QoS level; and
at least one or more MEDIA FRAME HINT nodes, each of which is connected to the MEDIA SEGMENT HINT node as a subordinate node of the MEDIA SEGMENT HINT node and contains multimedia frame information to be actually transmitted.

10. The multimedia streaming apparatus of claim 9, wherein the STREAMING HINT node comprises:
a target bit rate adjuster which adjusts a transmission bit rate to the change of the network bandwidth;
a target quality adjuster which adjusts QoS of multimedia data to be provided for service;
a target complexity adjuster which supports differentiated services according to resource complexity of the client;
a target profile adjuster which supports differentiated services according to the compression format of the multimedia data;
a target speed adjuster which adjusts a service speed according to a reproduction speed adjusting request from the client;
a target direction adjuster which adjusts a service direction according to a reproduction direction adjusting request from the client; and
a target device adjuster which supports differentiated services according to the type of the client terminal.

11. The multimedia streaming apparatus of claim 9, wherein the HEADER GROUP HINT node comprises:
a stream identifier which distinguishes each multimedia stream when a plurality of multimedia objects are provided at the same time for service;
a stream type identifier which distinguishes the type of the multimedia data;
a scalable function identifier which distinguishes the type of a scalable function for the multimedia data;
a source location identifier which indicates location information of the multimedia data stored in the data storage unit;
a frame rate identifier which indicates the frame rate of the multimedia data; and
an average bit rate identifier which indicates the average bit rate of the multimedia data.

12. The multimedia streaming apparatus of claim 9, wherein the HEADER GROUP HINT node contains the same number of FRAME HEADER HINT nodes as the number of multimedia objects to be provided for service.

13. The multimedia streaming apparatus of claim 9, wherein the SEGMENT GROUP HINT node contains the same number of the MEDIA SEGMENT HINT nodes as the number of the QoS levels.

14. The multimedia streaming apparatus of claim 9, wherein the MEDIA SEGMENT HINT node contains the same number of MEDIA FRAME HINT nodes as the number of entire frames to be provided for service at each QoS level.

15. The multimedia streaming apparatus of claim 9, wherein the MEDIA FRAME HINT node comprises:
a stream identifier which distinguishes each multimedia stream when a plurality of multimedia objects are provided at the same time for service;
a decoding/reproduction time identifier which indicates decoding time information and reproduction time information of a frame;
a coding type identifier which distinguishes frames into I frames, P frames, and B frames according to a method a frame is referred to when the frame is encoded;
a frame offset identifier which indicates location information of each frame of the multimedia data stored in the data storage unit;
a frame length identifier which indicates the size of a corresponding frame; and
a frame number identifier which indicates the number of a corresponding frame.

16. The multimedia streaming apparatus of claim 9, wherein the metadata is broken down into independent-type metadata and dependent-type metadata according to an attribute of the MEDIA SEGMENT HINT node.

17. The multimedia streaming apparatus of claim 16, wherein each node of the independent-type metadata contains frame information of multimedia data corresponding to a service level without reference to an upper node or reuse.

18. The multimedia streaming apparatus of claim 16, wherein each node of the dependent-type metadata refers to an upper node for information shared at a plurality of QoS levels and specifies only additional information in a lower node.

19. The multimedia streaming apparatus of claim 2, wherein if the number of the QoS levels increases, the frame drop rate of the multimedia streaming server gradually decreases and the average bit rate and average peak signal to noise ratio (PSNR) value gradually increase.

20. The multimedia streaming apparatus of claim 1, wherein the multimedia streaming client comprises:
a packet receiving unit which receives the multimedia data from the server;
a buffer which stores the received multimedia data;
a multimedia decoder which reproduces the data stored in the buffer;
a bandwidth measuring unit which measures a network bandwidth by using the time when the multimedia data is received in the packet receiving unit and the size information of the data; and
a message transmission unit which transmits the measured network bandwidth to the server so that the transmission rate of the multimedia data transmitted from the server is adjusted to the network bandwidth.

21. The multimedia streaming apparatus of claim 20, wherein the packet receiving unit distinguishes the first packet and the last packet of each packet group by referring to the packet number of the received multimedia data.

22. The multimedia streaming apparatus of claim 21, wherein assuming that a time when the first packet is received is t1, a time when the last packet is received is t2, and the size of the packet group data is Sp, the network bandwidth is obtained by the following equation:
$${E}_{BW} ( Bandwidth ) = \frac{{S}_{p} \times 8 \times 1000}{{t}_{2} - {t}_{1}}$$

23. The multimedia streaming apparatus of claim 20, wherein the bandwidth measuring unit feeds the network bandwidth information back to the server through the message transmission unit whenever the network bandwidth varies.

24. A multimedia streaming server comprising:
a data storage unit which stores multimedia data desired to be provided for service and metadata related to the multimedia data;
a metadata parsing unit which parses the metadata and outputs the parsing result in the form of a descriptor;
a message receiving unit which receives network bandwidth information from a client connected to a network;
a quality of service (QoS) processing unit which selects a QoS level available for service in response to the descriptor information and the network bandwidth information, and extracts multimedia data corresponding to the selected QoS level, from the data storage unit;
a buffer which stores the extracted data;
a packet generation unit which packetizes the data stored in the buffer; and
a packet transmission unit which transmits the packet data to the client in each predetermined time interval.

25. The multimedia streaming server of claim 24, wherein the QoS processing unit comprises:
a service level selection unit which compares a target bit rate for each QoS level with the bandwidth and selects a predetermined QoS level; and
a frame selection unit which extracts frames corresponding to the QoS level from the multimedia data stored in the data storage unit and stores the extracted frames in the buffer.

26. The multimedia streaming server of claim 24, wherein the buffer comprises:
a packet storage buffer which stores the packet data generated by the packet generation unit; and
a packet transmission buffer which transmits the packet data.

27. The multimedia streaming server of claim 24, wherein the multimedia data has any one form of audio data, moving picture data, still picture data, text data, and graphic data.

28. The multimedia streaming server of claim 24, wherein the multimedia data is formed with a bit stream which has any one of a spatial scalable function, a quality scalable function, a temporal scalable function, and fine grain scalable (FGS) function.

29. The multimedia streaming server of claim 24, wherein the metadata is defined based on an extensible markup language (XML).

30. The multimedia streaming server of claim 24, wherein the metadata has a hierarchical structure in the form of a tree having the multimedia data and streaming-related information.

31. The multimedia streaming server of claim 30, wherein the metadata comprises:
a STREAMING HINT node which specifies the control type of the metadata and the type of the hierarchical structure of a node;
a HEADER GROUP HINT node which is connected to the STREAMING HINT node as a subordinate node of the STREAMING HINT node and contains header information of the multimedia data;
at least one or more SEGMENT GROUP HINT nodes, each of which is connected to the STREAMING HINT node as a subordinate node of the STREAMING HINT node and contains segment information when the multimedia is divided into segments of a predetermined time interval;
at least one or more FRAME HEADER HINT nodes, each of which is connected to the HEADER GROUP HINT node as a subordinate node of the HEADER GROUP HINT node, and contains an attribute value indicating unique information of each node;
at least one or more MEDIA SEGMENT HINT nodes, each of which is connected to the SEGMENT GROUP HINT node as a subordinate node of the SEGMENT GROUP HINT node, and contains attribute information on each QoS level; and
at least one or more MEDIA FRAME HINT nodes, each of which is connected to the MEDIA SEGMENT HINT node as a subordinate node of the MEDIA SEGMENT HINT node and contains multimedia frame information to be actually transmitted.

32. The multimedia streaming server of claim 31, wherein the STREAMING HINT node comprises:
a target bit rate adjuster which adjusts a transmission bit rate to the change of the network bandwidth;
a target quality adjuster which adjusts QoS of multimedia data to be provided for service;
a target complexity adjuster which supports differentiated services according to resource complexity of the client;
a target profile adjuster which supports differentiated services according to the compression format of the multimedia data;
a target speed adjuster which adjusts a service speed according to a reproduction speed adjusting request from the client;
a target direction adjuster which adjusts a service direction according to a reproduction direction adjusting request from the client; and
a target device adjuster which supports differentiated services according to the type of the client terminal.

33. The multimedia streaming server of claim 31, wherein the HEADER GROUP HINT node comprises:
a stream identifier which distinguishes each multimedia stream when a plurality of multimedia objects are provided at the same time for service;
a stream type identifier which distinguishes the type of the multimedia data;
a scalable function identifier which distinguishes the type of a scalable function for the multimedia data;
a source location identifier which indicates location information of the multimedia data stored in the data storage unit;
a frame rate identifier which indicates the frame rate of the multimedia data; and
an average bit rate identifier which indicates the average bit rate of the multimedia data.

34. The multimedia streaming server of claim 31, wherein the HEADER GROUP HINT node contains the same number of FRAME HEADER HINT nodes as the number of multimedia objects to be provided for service.

35. The multimedia streaming server of claim 31, wherein the SEGMENT GROUP HINT node contains the same number of the MEDIA SEGMENT HINT nodes as the number of the QoS levels.

36. The multimedia streaming server of claim 31, wherein the MEDIA SEGMENT HINT node contains the same number of MEDIA FRAME HINT nodes as the number of entire frames to be provided for service at each QoS level.

37. The multimedia streaming server of claim 31, wherein the MEDIA FRAME HINT node comprises:
a stream identifier which distinguishes each multimedia stream when a plurality of multimedia objects are provided at the same time for service;
a decoding/reproduction time identifier which indicates decoding time information and reproduction time information of a frame;
a coding type identifier which distinguishes frames into I frames, P frames, and B frames according to a method a frame is referred to when the frame is encoded;
a frame offset identifier which indicates location information of each frame of the multimedia data stored in the data storage unit;
a frame length identifier which indicates the size of a corresponding frame; and
a frame number identifier which indicates the number of a corresponding frame.

38. The multimedia streaming server of claim 31, wherein the metadata is broken down into independent-type metadata and dependent-type metadata according to an attribute of the MEDIA SEGMENT HINT node.

39. The multimedia streaming server of claim 38, wherein each node of the independent-type metadata contains frame information of multimedia data corresponding to a service level without reference to an upper node or reuse.

40. The multimedia streaming a server of claim 38, wherein each node of the dependent-type metadata refers to an upper node for information shared at a plurality of QoS levels and specifies only additional information in a lower node.

41. The multimedia streaming server of claim 24, wherein if the number of the QoS levels increases, the frame drop rate of the multimedia streaming server gradually decreases and the average bit rate and average peak signal to noise ratio (PSNR) value gradually increase.

42. A multimedia streaming client comprising:
a packet receiving unit which receives the multimedia data from a server connected to a network;
a buffer which stores the received multimedia data;
a multimedia decoder which reproduces the data stored in the buffer;
a bandwidth measuring unit which measures a network bandwidth by using the time when the multimedia data is received in the packet receiving unit and the size information of the data; and
a message transmission unit which transmits the measured network bandwidth to the server so that the transmission rate of the multimedia data transmitted from the server is adjusted to the network bandwidth.

43. The multimedia streaming client of claim 42, wherein the packet receiving unit distinguishes the first packet and the last packet of each packet group by referring to the packet number of the received multimedia data.

44. The multimedia streaming client of claim 43, wherein assuming that a time when the first packet is received is t1, a time when the last packet is received is t2, and the size of the packet group data is Sp, the network bandwidth is obtained by the following equation:
$${E}_{BW} ( Bandwidth ) = \frac{{S}_{p} \times 8 \times 1000}{{t}_{2} - {t}_{1}}$$

45. The multimedia streaming client of claim 42, wherein the bandwidth measuring unit feeds the network bandwidth information back to the server through the message transmission unit whenever the network bandwidth varies.

46. A multimedia streaming method to be performed between a server and a client that are connected through a network, the method comprising:
(a) the client transmitting a service request message and session connection request message to the server;
(b) transmitting a service confirmation message on the request message and a pair of dummy packets to the client;
(c) in response to the pair of packets transmitted by the server, determining an initial bandwidth value of the network and transmitting the determined initial bandwidth value to the server;
(d) comparing the initial bandwidth information transmitted by the client with descriptor information obtained as a result of parsing metadata, determining an appropriate QoS level, and starting to provide multimedia streaming service according to a transmission rate corresponding to the QoS level;
(e) in response to packet information transmitted by the streaming service of the server, measuring the network bandwidth periodically and transmitting the measured bandwidth value to the server; and
(f) according to the network bandwidth value transmitted by the client, extracting a predetermined multimedia stream, and transmitting the extracted multimedia stream to the client.

47. The multimedia streaming method of claim 46, wherein the step (e) comprises:
(e-1) setting the size value of an accumulated packet to 0;
(e-2) starting to receive a packet from the server;
(e-3) setting the time when a first packet is received as T1;
(e-4) after the first packet is input till a last packet is input, whenever a packet is input, accumulating the size value of the packet to the size of the accumulated packet;
(e-5) if the last packet is input, setting the time when the last packet is input as T2;
(e-6) measuring the network bandwidth by calculating
$$\frac{Accumulated packet size \times 1000 \times 8}{TS2 - TS1} ;$$
(e-7) feeding the measured network bandwidth information back to the server.

48. The multimedia streaming method of claim 46, wherein the multimedia data has any one form of audio data, moving picture data, still picture data, text data, and graphic data.

49. The multimedia streaming method of claim 48, wherein the multimedia data is formed with a bit stream which has any one of a spatial scalable function, a quality scalable function, a temporal scalable function, and fine grain scalable (FGS) function.

50. The multimedia streaming method of claim 46, wherein the metadata is defined based on an extensible markup language (XML).

51. The multimedia streaming method of claim 50, wherein the metadata has a hierarchical structure in the form of a tree having the multimedia data and streaming-related information.

52. The multimedia streaming method of claim 46, wherein if the number of the QoS levels increases, the frame drop rate of the multimedia streaming server gradually decreases and the average bit rate and average peak signal to noise ratio (PSNR) value gradually increase.

53. A streaming method of a server which is connected to a client through a network, the method comprising:
(a) receiving the bandwidth of the network from the client;
(b) based on a descriptor obtained as a result of parsing metadata corresponding to multimedia data desired to be provided for service, selecting a current time segment;
(c) comparing a target bit rate defined in the descriptor for the selected segment with the network bandwidth, selecting a QoS level available for service; and
(d) extracting frames corresponding to the selected QoS level and transmitting the frames to the client at each predetermined time interval.

54. The streaming method of claim 53, wherein the multimedia data has any one form of audio data, moving picture data, still picture data, text data, and graphic data.

55. The streaming method of claim 54, wherein the multimedia data is formed with a bit stream which has any one of a spatial scalable function, a quality scalable function, a temporal scalable function, and fine grain scalable (FGS) function.

56. The streaming method of claim 53, wherein the metadata is defined based on an extensible markup language (XML).

57. The streaming method of claim 56, wherein the metadata has a hierarchical structure in the form of a tree having the multimedia data and streaming-related information.

58. The streaming method of claim 53, wherein if the number of the QoS levels increases, the frame drop rate of the multimedia streaming server gradually decreases and the average bit rate and average peak signal to noise ratio (PSNR) value gradually increase.

59. A network bandwidth measuring method of a client which receives multimedia data from a server through a network, the method comprising:
(a) setting the size value of an accumulated packet to 0;
(b) starting to receive a packet from the server;
(c) setting the time when a first packet is received as T1;
(d) after the first packet is input till a last packet is input, whenever a packet is input, accumulating the size value of the packet to the size of the accumulated packet;
(e) if the last packet is input, setting the time when the last packet is input as T2;
(f) measuring the network bandwidth by calculating
$$\frac{Accumulated packet size \times 1000 \times 8}{TS2 - TS1} ;$$
(g) feeding the measured network bandwidth information back to the server.

60. A computer readable medium having embodied thereon a computer program for performing the method of claim 46.

61. A computer readable medium having embodied thereon a computer program for performing the method of claim 53.

62. A computer readable medium having embodied thereon a computer program for performing the method of claim 59.
